(19) United States
(12) Patent Application Publication
(10) Pub. No.: US 2013/0189540 A1
(43) Pub. Date: Jul. 25, 2013

(54) Cooper-Zinc-Manganese Alloys with Silvery-White Finish for Coinage and Token Applications

(71) Applicants: Paul McDaniel, Jupiter, FL (US); Jon Headrick, Knoxville, TN (US); Randy Beets, Bulls Gap, TN (US)

(72) Inventors: Paul McDaniel, Jupiter, FL (US); Jon Headrick, Knoxville, TN (US); Randy Beets, Bulls Gap, TN (US)

(73) Assignee: JARDEN ZINC PRODUCTS, LLC, Greeneville, TN (US)

(21) Appl. No.: 13/824,758

(22) PCT Filed: Oct. 7, 2011
(86) PCT No.: PCT/US11/01732

§ 371 Date: Mar. 18, 2013

Related U.S. Application Data
(60) Provisional application No. 61/390,637, filed on Oct. 7, 2010.

(51) Int. Cl. A44C 21/00; C22C 9/04; C25D 7/06; B32B 15/01

(52) U.S. Cl. CPC A44C 21/00; B32B 15/01; C22C 9/04; C25D 7/0614
USPC 428/675; 420/481; 420/482; 420/473; 205/152

(57) ABSTRACT

Alloys of copper and manganese and copper, manganese and zinc can be used for the production of coins, such as the U.S. five cent piece or “nickel.” With appropriate platings, these alloys can match the electromagnetic signatures or electrical conductivity of currently circulated coins. This is important as modern vending machines include sensors which measure the conductivity of coins to ensure they are genuine.

### FIELD OF THE DISCLOSURE

The present disclosure relates to a cost-effective replacement for cupronickel alloys used in coinage. An alloy composed of copper and manganese was initially investigated. As a family, these alloys are known as manganins. After achieving success with copper-manganese alloys, a significantly lower cost alloy was produced by replacing a portion of the copper with zinc. Small additions of nickel or tin to the alloy were made to allow defective plated blanks or defaced coins to be recycled back into the alloying furnace with their plating intact.

### BACKGROUND AND SUMMARY

Cupronickel, an alloy of copper and nickel, is used in a wide variety of coinage and tokens worldwide. Although copper comprises the majority of the alloy, cupronickel has the silvery-white appearance of nickel. A cupronickel alloy comprised of 75% copper/25% nickel (Alloy C71300) is used in most U.S. circulation coins. The five cent coin, popularly known as the “nickel,” is solid cupronickel. The ten, twenty-five and fifty cent and Susan B. Anthony one-dollar coins have a copper core (Alloy C11000) clad with cupronickel.

Due to fluctuating metals prices, particularly that of nickel, the U.S. five cent coin has cost more to produce than its face value at various times over the past few years. This situation is known in the minting industry as negative seigniorage. The cupronickel-clad U.S. coins don't have this problem at this time, because their overall nickel content is substantially lower, and their face value is higher. Of course, this situation is subject to change. Other countries using cupronickel coinage are facing the same issues.

All cupronickel coins minted in the U.S. can be used in vending machines. Most modern machines use an electronic coinage acceptor that measures the coin's conductivity, diameter, and thickness using inductive sensor technology. The combination of these properties is known as the coin's electromagnetic signature (EMS). No matter how accurately a counterfeiter re-creates the configuration of a coin, he cannot successfully “slug” the vending machine unless the conductivity of his slugs is within the range of the real coin. Furthermore, some coinage acceptors measure the conductivity at multiple frequencies, and various brands of acceptors use different measurement frequencies. This makes it all the more difficult to achieve an across-the-board conductivity match.

These anti-counterfeiting measures make it more difficult for mints to change the materials used in their coins when a negative seigniorage situation is encountered. Unless they produce a replacement that will match the existing material almost exactly, they will likely have to choose one of the following options:

1. Convince the vending industry to add additional channels to their machines, so that both the old and new materials will be recognized. Many machines have only four channels, used for five, ten, twenty-five cent coins and dollar coins;
2. Convince the vending industry to widen the acceptable range of conductivity for the channel used for the coin being replaced, so that both the old and new materials will be accepted. This wider “window” may significantly reduce the security of the machine against counterfeiters; or
3. Notify the public that the new coins are not usable in many vending machines. This is not likely to be politically popular.

### DESCRIPTION OF THE DRAWINGS

In the drawings:

FIG. 1 is a graph of electrical conductivity as a function of sensor frequency showing the effect of copper plating thickness over steel blanks, with a 4 um (micron) nickel top plating layer;

FIG. 2 is a graph of electrical conductivity as a function of sensor frequency of a stainless steel blank plated with a copper-nickel plating and that of a United States five cent coin (nickel);

FIG. 3 is a graph of electrical conductivity of a copper-manganese alloy as a function of the percent by weight of manganese present in the alloy;

FIG. 4 is a graph of the change of electrical conductivity as a function of nickel plating thickness and white bronze plating thickness on a U.S. five cent coin;

FIG. 5 is a graph of electrical conductivity of various platings on a copper-manganese alloy as a function of sensor measurement frequency;

FIG. 6 is a graph of electrical conductivity of a copper-zinc-manganese blank as a function of the weight content of manganese.

FIG. 7 is a graph of the electrical conductivity of U.S. five cent coins (nickels) and a nickel-plated copper-zinc-manganese-nickel alloy with different plating thicknesses as a function of sensor frequency;

FIG. 8 is a graph of the electrical conductivity of a nickel-plated copper-manganese alloy with various plating thicknesses compared to a U.S. five cent piece (nickel) as a function of sensor frequency;

FIG. 9 is a graph of the change in electrical conductivity of a nickel plated copper-zinc-manganese-nickel alloy and a copper-manganese alloy as a function of nickel plating thickness;

FIG. 10 is a graph of the effect of the manganese content in a copper-zinc-manganese-nickel alloy upon the average conductivity, and shows the measurement differences obtained using two different methods of chemical analysis; and

FIG. 11 is a graph of the effect of annealing upon the average conductivity of copper-zinc-manganese-nickel alloys.

### DETAILED DESCRIPTION OF REPRESENTATIVE EMBODIMENTS

The current disclosure identifies a cost-effective replacement material that behaves the same way in vending equipment as the existing solid cupronickel U.S. five cent coin, commonly known as the “nickel.” A coin blank with the same electrical conductivity as cupronickel across a wide range of electromagnetic measurement frequencies is difficult to achieve with electroplated materials, because the depth of penetration of the eddy currents induced by the vending equipment sensors varies with the measurement frequency. As the frequency is increased, the depth of penetration decreases, meaning that the plating layer becomes more significant to the overall conductivity reading.

Initial testing was conducted on various substrates, including carbon steel, 316 stainless steel, copper, and brasses with copper/zinc contents of 95%/5%, 85%/15%, and 70%/30%. Nickel plating and white bronze plating were tested over the various substrates, sometimes plated directly onto the substrate, sometimes over an initial deposit of copper plating. The variation in conductivity with frequency was significant in all cases.

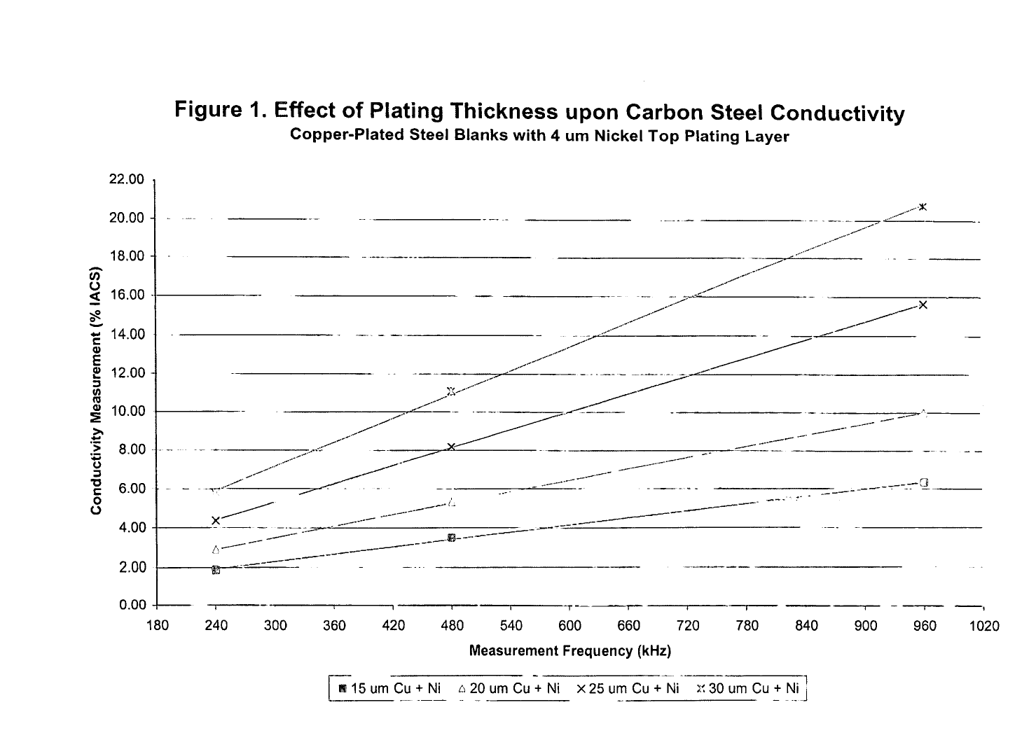

Electroplated carbon steel is widely used in world coinage, and is the least expensive substrate available. As shown in FIG. 1, it is possible to obtain a match to cupronickel, if the measurement frequency is known, and if all devices in which the coin is expected to function will operate at that frequency. All four configurations shown would exhibit the same conductivity as cupronickel within a small band of frequencies around the point where their conductivity vs. frequency lines cross the 5.5% IACS line. IACS stands for “International Annealed Copper Standard.” An IACS conductivity of, for example, 5% represents a conductivity of 5% of that of “pure” copper, as established by this standard. As used herein, the term “about” means plus or minus 10%.

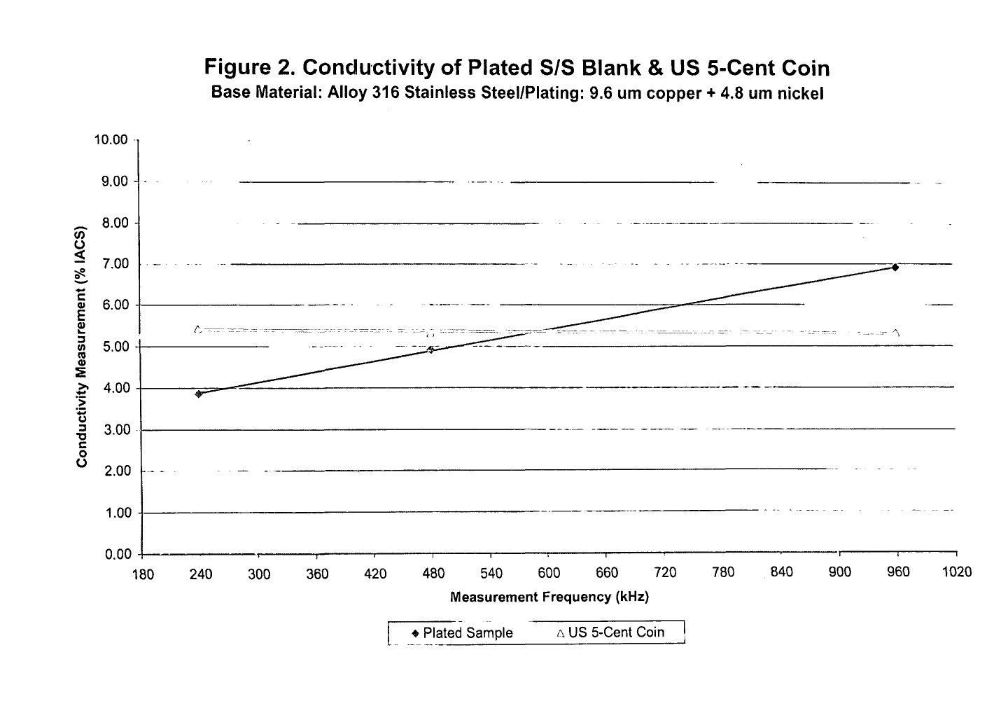

One of the closest matches was obtained with Alloy 316 Stainless Steel, electroplated first with 9.6 μm of copper, followed by 4.8 μm of nickel plating. These results are shown in FIG. 2. It is evident that the slope of the conductivity vs. frequency line in FIG. 2 is significantly less than those in FIG. 1. It is likely that this material would be an acceptable cupronickel replacement to a sensor operating in the range of 550 to 650 kHz. However, it is evident that sensors operating at lower frequencies would reject the material for low conductivity, and that those operating at higher frequencies would reject it for high conductivity.

A need existed to identify or develop a low cost alloy with the required conductivity across a wide range of measurement frequencies. Additionally, if the alloy required an electroplated finish for color matching and/or corrosion resistance purposes, the effect of plating upon EMS would have to be minimized.

Research turned to a zinc-based alloy for this application. The inherent conductivity of Alloy 190 zinc, used in the U.S. Penny, is about 28% IACS, so it is necessary to alloy zinc with another metal to achieve the desired conductivity, in this case around 5.5% IACS representing that of the U.S. nickel. Manganese has a very low conductivity and, when alloyed with other metals, is capable of significantly lowering the conductivity of the resulting alloy. Experiments with zinc-manganese alloys ultimately achieved the target conductivity of 5.5% IACS, but the alloy was far too brittle to allow rolling, rendering it unsuitable for use in coinage.

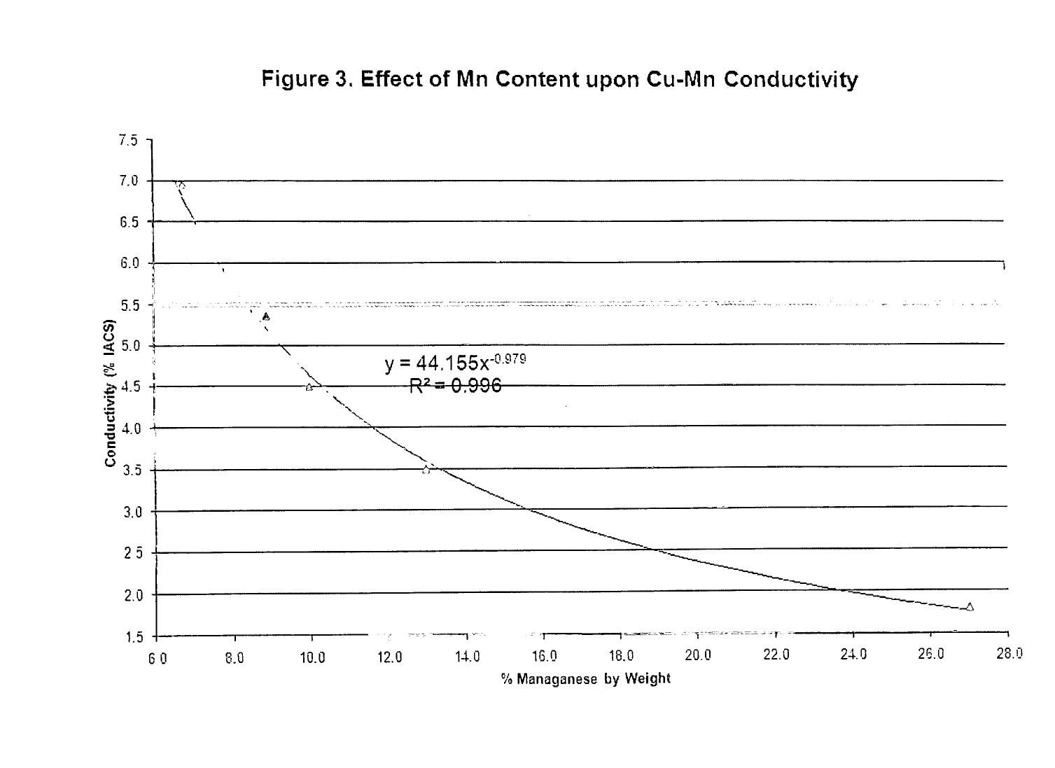

Copper-manganese alloys were then considered. Copper-manganese alloys could be produced with sufficient manganese content to drop the conductivity well below the 5.5% IACS level. It remained to determine just what that manganese content should be. As seen in FIG. 3, the first two samples had manganese contents of 6.8 and 8.9% and conductivities of 6.96% and 5.36% IACS at 68 kHz, respectively. Combining this test data with other data for manganin alloys yields a plot as shown in FIG. 3. From this plot, it was concluded that a composition of about 8.4-8.5% manganese, balance copper, should be targeted to achieve 5.5% IACS conductivity. The excellent fit of the data shows that the alloy conductivity can be controlled over a wide range by careful selection of the manganese content.

Five slabs, 1 in.×6 in.×12 in., were cast in a mold to this composition of about 8.4-8.5% manganese, balance copper from a molten state. The as-cast conductivity averaged 5.48% IACS at 68 kHz. The faces of the slabs were machined to make them smooth. Then the slabs were rolled in multiple passes to a gauge of approximately 0.064 inch. The resulting strips were passed through a blanking press to produce coin blanks 0.837 inch in diameter. These blanks were then passed through a rimming machine to reduce the diameter to 0.827 inch. This thickness and diameter are the specified dimensions for the U.S. 5¢ blank.

The blanks had an average hardness of 78.3 on the Rockwell 30T superficial hardness scale and an average conductivity of 5.49% IACS (average at 7 different frequencies). After annealing at 1000° F., the blanks had a hardness of 48.5 Rockwell 30T and an average conductivity of 5.59% IACS.

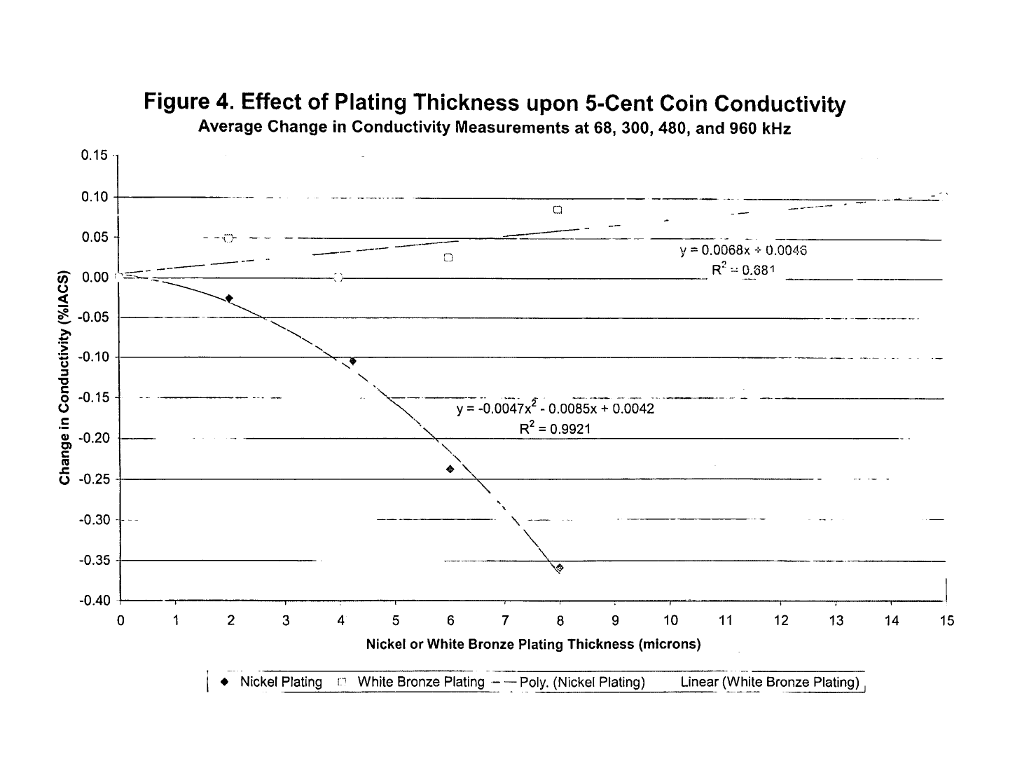

The blanks had a reddish-brown color, so it was necessary to electroplate them to provide the desired silvery-white color. Experiments with actual U.S. five cent coins were conducted by plating various thicknesses of both nickel and white bronze. Results of that investigation are shown in FIG. 4.

Fifty (50) Cu—Mn blanks were electroplated as follows: (1) nickel plating, 2.4 μm thickness at the center of the blank; (2) nickel plating, 5.0 μm center thickness; (3) white bronze (tin-copper alloy) plating, 2.1 μm center thickness; and (4) white bronze plating, 5.7 μm center thickness. The nickel-plated blanks were baked at 1000° F. to provide stress relief to the plating. The white bronze-plated blanks don't require this process step. All four sets were then burnished in a centrifugal-disk machine to provide a bright, silvery-white finish.

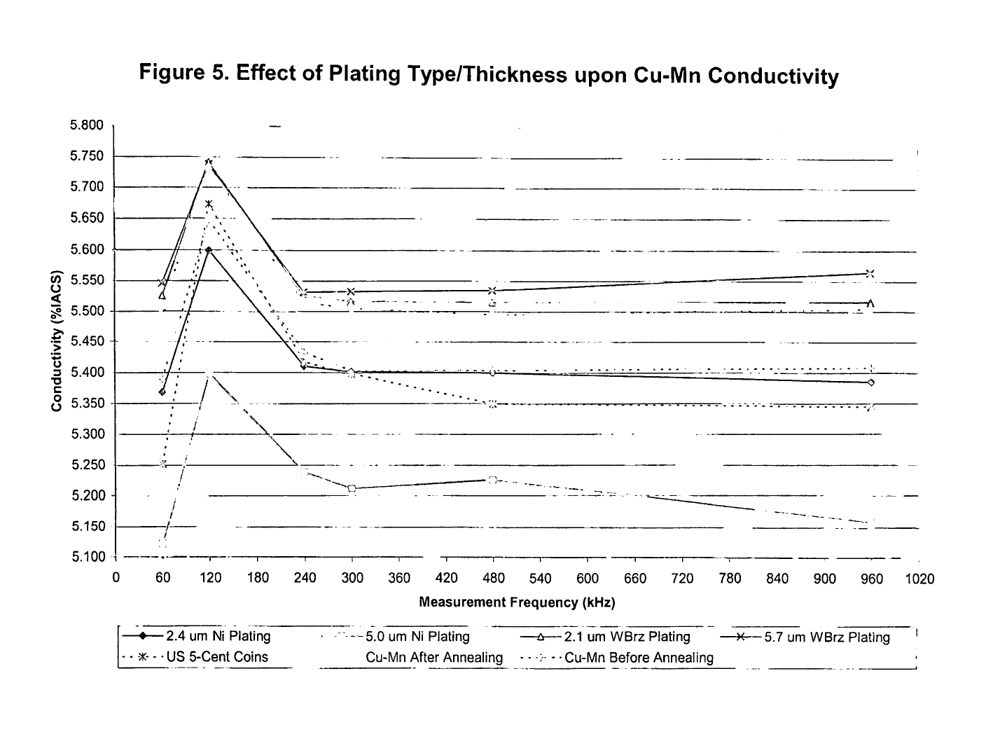

The finished blanks were then tested for conductivity at frequencies of 60, 120, 240, 300, 480, and 960 kHz. Actual U.S. five cent coins and unplated Cu—Mn blanks (before and after annealing) were also tested for reference. The results are shown in FIG. 5.

Several conclusions can be drawn from the data in FIGS. 4 and 5:

1. Nickel plating has a much greater effect upon conductivity than white bronze plating of a similar thickness. This is due to the fact that nickel is ferromagnetic, which affects the sensors. Although the true conductivity of nickel (when measured by other techniques) is approximately 23% IACS, inductive sensors indicate a much lower conductivity when measuring pure nickel (<1% IACS).
2. White bronze plating is more “transparent” to conductivity readings, because it is not ferromagnetic, and its inherent conductivity is reasonably close to that of cupronickel. Virtually no effect is seen at either thickness level at measurement frequencies below 300 kHz. At higher frequencies, the conductivity of 5.7 μm thickness samples deviates slightly from that of the unplated samples.
3. Due to the higher-than-expected conductivity of the Cu—Mn alloy after annealing and prior to plating, the 2.4 μm nickel-plated samples were the closest to matching the conductivity of the U.S. nickel across the spectrum of measurement frequencies.

These samples were then tested in six different models of electronic coinage acceptors, from four different manufacturers. Also tested were unplated, annealed Cu—Mn blanks. The same ten blanks of each type were passed through each machine, and the number of successful passes was recorded. Any blanks that failed were passed through a second time, and, if necessary, a third time. Results are shown in Table 1.

TABLE 1
Cu−Mn Blank Acceptance Data for Six Coinage Mechanisms

| | | 2.4 μm | 5.0 μm | 2.1 μm | 5.7 μm |
|---|---|---|---|---|---|
| Test Blank Finish | None | Ni | Ni | WBrz | WBrz |
| Machine # 1 | | | | | |
| 1st Pass | 10/10 | 8/10 | 10/10 | 9/10 | 9/10 |
| 2nd Pass | N/A | 2/2 | N/A | 1/1 | 1/1 |
| 3rd Pass | N/A | N/A | N/A | N/A | N/A |
| Machine # 2 | | | | | |
| 1st Pass | 9/10 | 8/10 | 0/10 | 9/10 | 10/10 |
| 2nd Pass | 0/1 | 1/2 | 0/10 | 1/1 | N/A |
| 3rd Pass | 0/1 | 1/1 | 0/10 | N/A | N/A |
| Machine # 3 | | | | | |
| 1st Pass | 3/10 | 10/10 | 6/10 | 8/10 | 10/10 |
| 2nd Pass | 2/7 | N/A | 4/4 | 1/2 | N/A |
| 3rd Pass | 2/5 | N/A | N/A | 1/1 | N/A |
| Machine # 4 | | | | | |
| 1st Pass | 10/10 | 10/10 | 10/10 | 9/10 | 10/10 |
| 2nd Pass | N/A | N/A | N/A | 1/1 | N/A |
| 3rd Pass | N/A | N/A | N/A | N/A | N/A |
| Machine # 5 | | | | | |
| 1st Pass | 10/10 | 8/10 | 6/10 | 9/10 | 9/10 |
| 2nd Pass | N/A | 0/2 | 1/4 | 1/1 | 1/1 |
| 3rd Pass | N/A | 0/2 | 0/3 | N/A | N/A |
| Machine # 6 | | | | | |
| 1st Pass | 8/10 | 5/10 | 10/10 | 8/10 | 6 /10 |
| 2nd Pass | 0/2 | 1/5 | N/A | 0/2 | 1/4 |
| 3rd Pass | 0/2 | 0/4 | N/A | 0/2 | 0/3 |
| # 1st Pass Failures | 10 | 11 | 18 | 8 | 6 |
| # 1st Passes | 60 | 60 | 60 | 60 | 60 |
| 1-Pass Acceptance Rate | 83.3% | 81.7% | 70.0% | 86.7% | 90.0% |
| # 2nd Pass Failures | 8 | 7 | 13 | 3 | 3 |
| 2-Pass Acceptance Rate | 86.7% | 88.3% | 78.3% | 95.0% | 95.0% |
| # 3rd Pass Failures | 6 | 6 | 13 | 2 | 3 |
| 3-Pass Acceptance Rate | 90.0% | 90.0% | 78.3% | 96.7% | 95.0% |
| # Machines with Issues | 2 | 2 | 2 | 1 | 1 |
| Affected Machines | # 2 & | # 5 & | # 2 & | # 6 | # 6 |
| | # 6 | # 6 | # 5 | | |

After testing the plated copper-manganese blanks, it was realized that a significant reduction in the cost of the alloy could be achieved by substituting a portion of the copper with zinc. This would require a determination of a new optimal level of manganese in the alloy, as copper-zinc alloys (brasses) are considerably less conductive than copper. A lesser manganese content could then be required to meet a 5.5% IACS conductivity target.

The approach was to start with three alloys, all containing approximately 30% zinc, one each with 3%, 5%, and 7% manganese nominal, and the balance copper. Using the same techniques as before, slabs were rolled to the desired gauge (0.064 inch) and 0.827 inch rimmed coin blanks were produced. The blanks were then annealed at 1250° F. and the conductivity of each was measured. The results of these trials are shown in Table 2.

TABLE 2
Conductivity and Hardness of Cu—Zn—Mn Samples

| | 3% Mn | 5% Mn | 7% Mn |
|---|---|---|---|
| Alloy Composition | | | |
| % Copper | 67.15 | 65.76 | 63.45 |
| % Zinc | 29.80 | 29.53 | 29.66 |
| % Manganese | 3.05 | 4.71 | 6.89 |
| Slabs As-Cast | | | |
| Conductivity at 60 kHz | 9.125 | 6.672 | 5.244 |
| (% IACS) | | | |
| At 68 kHz | 9.109 | 6.659 | 5.201 |
| At 240 kHz | 9.161 | 6.646 | 5.203 |
| At 300 kHz | 9.171 | 6.688 | 5.232 |
| At 480 kHz | 9.123 | 6.616 | 5.176 |
| At 960 kHz | 9.068 | 6.580 | 5.137 |
| Average of All | 9.126 | 6.643 | 5.199 |
| Frequencies | | | |
| Rolled Strip Before | | | |
| Blanking | | | |
| Conductivity at 60 kHz | 8.889 | 6.390 | 4.853 |
| (% IACS) | | | |
| at 68 kHz | 9.127 | 6.643 | 5.021 |
| at 240 kHz | 8.530 | 6.297 | 4.999 |
| at 300 kHz | 8.610 | 6.355 | 5.008 |
| at 480 kHz | 8.564 | 6.303 | 4.944 |
| at 960 kHz | 8.598 | 6.301 | 4.955 |
| Average of All | 8.720 | 6.382 | 4.963 |
| Frequencies | | | |
| Hardness: | | | |
| Rockwell 30T | 78.1 | 78.5 | 78.5 |
| Rockwell B | 93.5 | 95.7 | 96.1 |
| After Blanking and | | | |
| Rimming | | | |
| Conductivity at 60 kHz | 8.952 | 6.437 | 4.894 |
| (% IACS) | | | |
| at 68 kHz | 9.445 | 6.906 | 5.256 |
| at 120 kHz | 8.776 | 6.556 | 5.202 |
| at 240 kHz | 8.572 | 6.296 | 5.029 |
| at 300 kHz | 8.649 | 6.366 | 5.026 |
| at 480 kHz | 8.603 | 6.298 | 4.943 |
| at 960 kHz | 8.613 | 6.303 | 4.954 |
| Average of All | 8.801 | 6.452 | 5.043 |
| Frequencies | | | |
| Hardness, Rockwell B | 94.9 | 95.4 | 96.9 |
| Coin Blanks After | | | |
| Annealing at 1250° F. | | | |
| Conductivity at 60 kHz | 9.604 | 6.804 | 4.938 |
| (% IACS) | | | |
| at 68 kHz | 10.040 | 7.233 | 5.285 |
| at 120 kHz | 9.348 | 6.841 | 5.209 |
| at 240 kHz | 9.211 | 6.626 | 5.040 |
| at 300 kHz | 9.238 | 6.661 | 5.029 |
| at 480 kHz | 9.266 | 6.651 | 4.994 |
| at 960 kHz | 9.296 | 6.683 | 5.022 |
| Average of All | 9.429 | 6.786 | 5.074 |
| Frequencies | | | |
| Hardness, Rockwell 30T | 21.3 | 28.8 | 34.8 |

It can be determined from these results that this 30% zinc alloy can be tailored across a wide range of conductivities, simply by adjusting the manganese content. These 3 samples fully processed as shown in Table 2 spanned the range from about 5.1 to 9.4% IACS average conductivity (5.0 to 9.3% IACS at frequencies from 240 to 960 kHz). It is evident that this range could have been expanded further by reducing the manganese content below 3% nominal or raising it above 7% nominal. It is also clear that variations in the zinc content would be feasible, as the zinc in commercial wrought brass alloys ranges from 5% (Gilding Metal, Alloy C21000) to 40% (Muntz Metal, Alloy C28000).

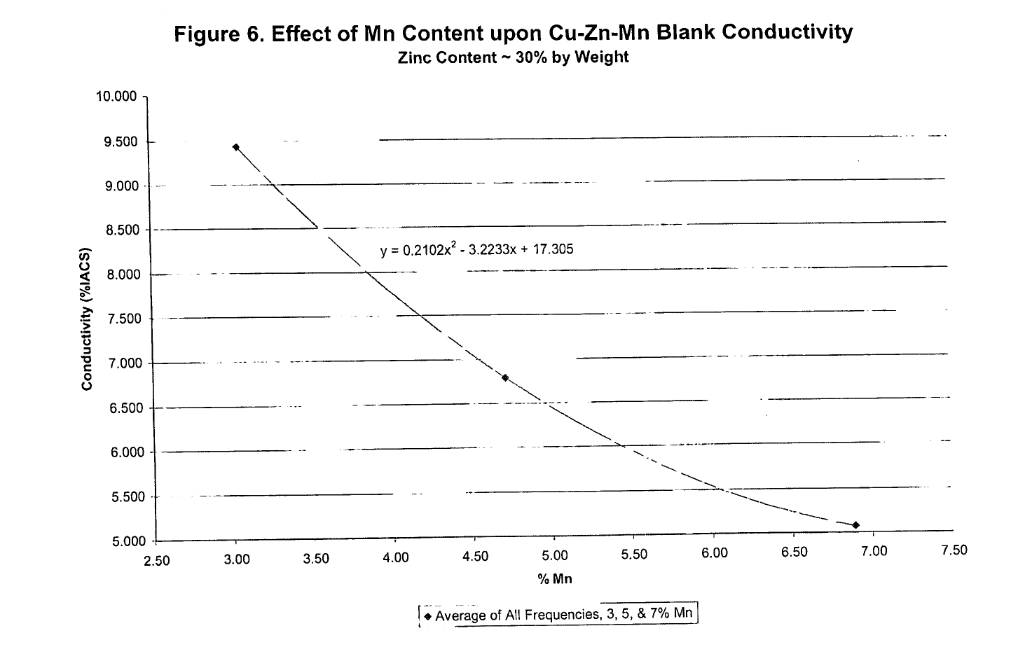

Coin blank conductivity results are plotted against actual manganese content in FIG. 6. Considering all three manganese levels indicated that a content of about 6.0-6.1% manganese would be appropriate for the next series of samples.

For this next series of samples, minor additions of nickel and tin were made to the alloy. The intention was to permit defective nickel-plated or white bronze-plated blanks, or defaced coins of each type, to be recycled directly into the alloying furnace. Based upon experience with the U.S. penny, it was determined that these metals need only be present at a content of <0.5% by weight to enable efficient recycling. Cast slab composition targets were as follows: (1) 30% Zn, 6% Mn, 0.35% Ni, balance Cu and (2) 30% Zn, 6% Mn, 0.20% Sn, balance Cu. However, the manganese content of both compositions as tested was higher than specified. Nonetheless, the slabs were rolled and produced coinage blanks as before. Conductivity and hardness results for these blanks, both before and after annealing, are shown in Table 3.

TABLE 3
Conductivity and Hardness of Cu—Zn—Mn Samples
with Minor Nickel and Tin Additions

| | Cu—Zn—Mn—Ni | Cu—Zn—Mn—Sn |
|---|---|---|
| Alloy Composition | | |
| % Copper | 63.26 | 62.71 |
| % Zinc | 29.63 | 30.36 |
| % Manganese | 6.68 | 6.71 |
| % Nickel | 0.43 | N/A |
| % Tin | N/A | 0.22 |
| After Blanking and | | |
| Rimming | | |
| Conductivity at 60 kHz | 5.214 | 5.356 |
| (% IACS) | | |
| at 68 kHz | 5.628 | 5.758 |
| at 120 kHz | 5.476 | 5.596 |
| at 240 kHz | 5.254 | 5.375 |
| at 300 kHz | 5.294 | 5.407 |
| at 480 kHz | 5.225 | 5.342 |
| at 960 kHz | 5.226 | 5.340 |
| Average of All | 5.331 | 5.454 |
| Frequencies | | |
| Hardness, Rockwell B | 98.7 | 99.6 |
| Coin Blanks After | | |
| Annealing at 1250° F. | | |
| Conductivity at 60 kHz | 5.513 | 5.525 |
| (% IACS) | | |
| at 68 kHz | 5.892 | 5.917 |
| at 120 kHz | 5.705 | 5.723 |
| at 240 kHz | 5.503 | 5.519 |
| at 300 kHz | 5.512 | 5.537 |
| at 480 kHz | 5.483 | 5.504 |
| at 960 kHz | 5.504 | 5.533 |
| Average of All | 5.587 | 5.608 |
| Frequencies | | |
| Hardness, Rockwell 30T | 32.8 | 33.3 |

It was surprising that the conductivity wasn't lower, considering the higher-than-intended manganese content. It is possible that this is attributable to the effects of the nickel and tin additions. It might also reflect inaccuracies in the chemical analysis of the alloy samples. Whatever the reason, it was encouraging that alloys were still quite close to the desired 5.5% IACS conductivity after annealing.

It is important to note that the minor nickel and tin additions had no adverse effect upon the processing of the respective alloys. It is reasonable to expect that a Cu—Mn or Cu—Zn—Mn alloy could also be produced with similar quantities of both nickel and tin, which would allow both nickel-plated and white bronze-plated versions of the alloy to be efficiently recycled into the same furnace for new alloy production.

Because the conductivity of the Cu—Zn—Mn—Sn alloy samples was already higher than the target, there was no need to plate them with white bronze. As noted above, the white bronze plating would be expected to increase the conductivity further. Since nickel plating lowers conductivity, only the Cu—Zn—Mn—Ni alloy samples were plated.

Fifty (50) of the Cu—Zn—Mn—Ni blanks, as well as 50 of the remaining Cu—Mn blanks produced earlier in the investigation, were nickel plated to a thickness of 2.7 μm. Ten (10) blanks of each type were baked at 1000° F. to relieve residual stresses in the nickel plating. This is necessary so that the plating can withstand the coining process without cracking. The remaining blanks were then reactivated by cathodic treatment in a sulfuric acid solution and nickel plated for additional times to achieve final nickel plating thicknesses of 3.4, 4.4, and 5.4 μm. Ten blanks of each type were produced at each level of thickness; each set of 10 was stress-relieved when its target thickness had been reached.

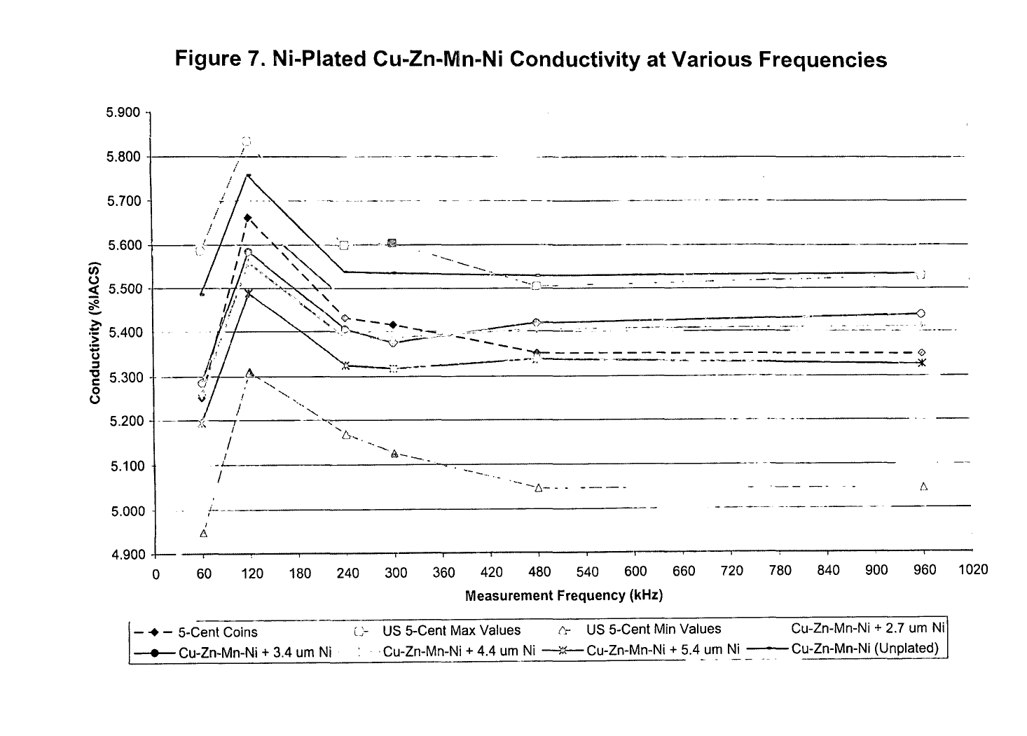

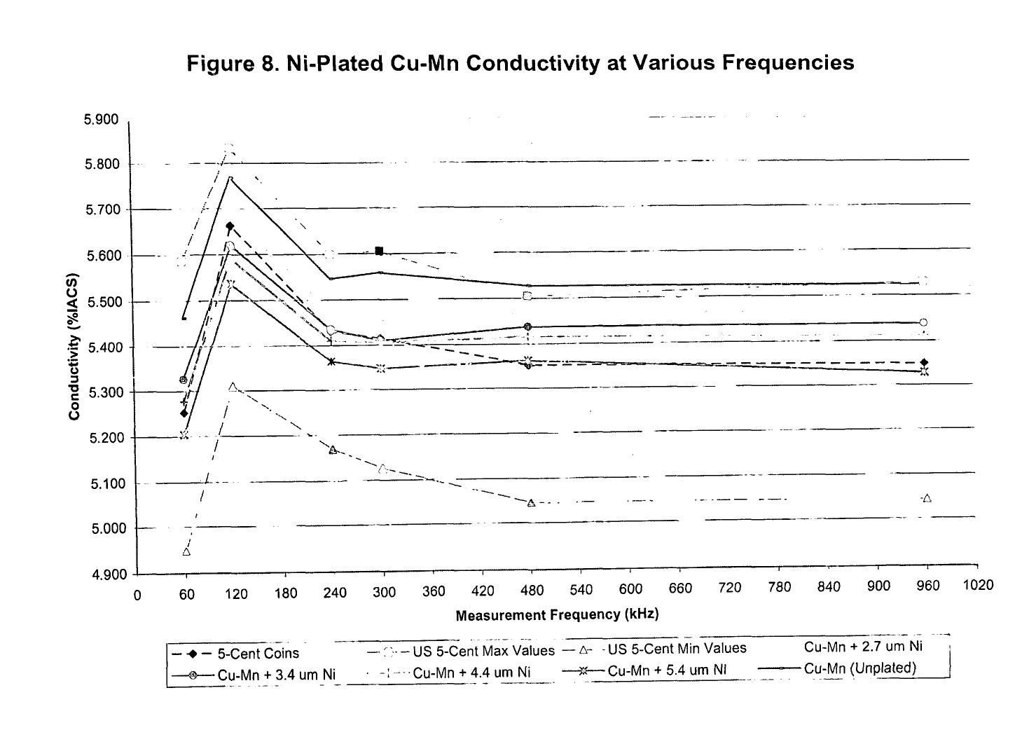

FIG. 7 shows the results of conductivity tests on the plated Cu—Zn—Mn—Ni blanks at various frequencies. FIG. 8 shows the same data for the Cu—Mn blanks. Data for unplated blanks and for U.S. five cent coins is also included. For reference, also shown is the maximum and minimum conductivity values at each frequency for a number (about 60) of five cent coins that were tested.

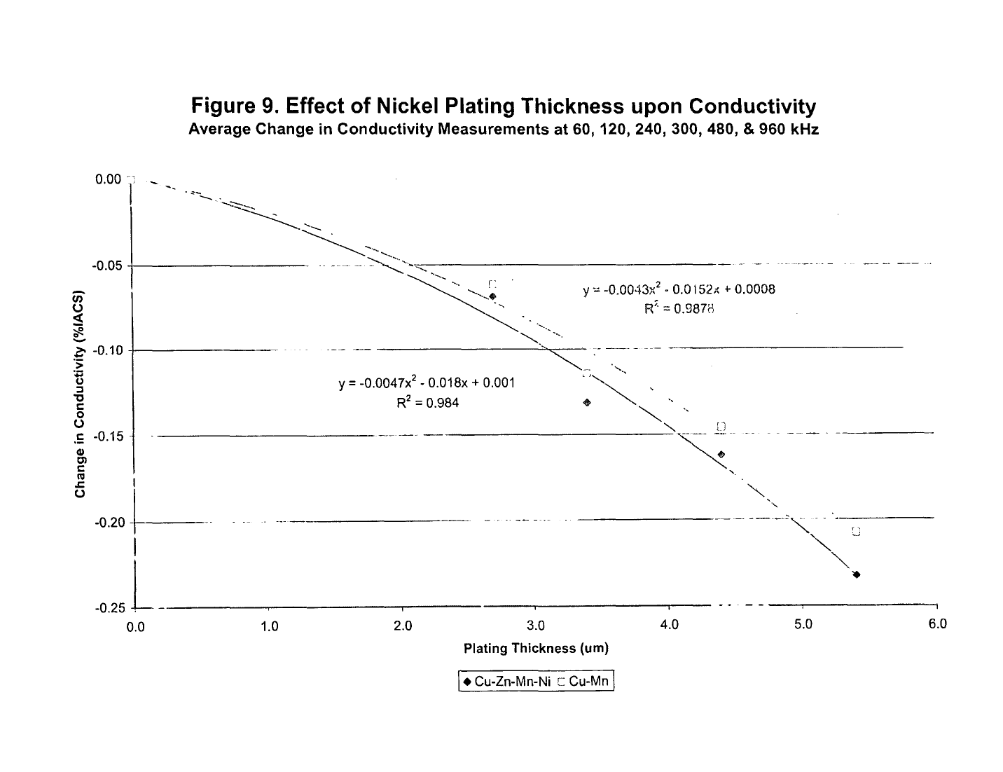

This data clearly shows that the conductivity measurement at any given frequency will be decreased as the nickel plating thickness is increased. It is interesting to note that the three lower plating thicknesses seem to more closely match the five cent coins at 60 to 300 kHz, but the 5.4 um data appears to be the best match at 480 and 960 kHz. In all cases, the plated blanks are well within the limits of the sampling of U.S. five cent coins. FIG. 9 shows the average change in conductivity attributable to the nickel plating thickness. Note the slightly different effects upon the two alloys.

The plated Cu—Zn—Mn—Ni blanks were then tested using the same six coinage acceptors as before. Once again, ten blanks of each type were passed through each machine, and the number of successful passes was recorded. Blanks that were rejected were passed through a second time, and, if necessary, a third time. Results are shown in Table 4.

TABLE 4
Cu—Zn—Mn—Ni Blank Acceptance
Data for Six Coinage Mechanisms

| | 2.7 μm | 3.4 μm | 4.4 μm | 5.4 μm |
|---|---|---|---|---|
| Test Blank Finish | Ni | Ni | Ni | Ni |
| Machine # 1 | | | | |
| 1^{st} Pass | 10/10 | 10/10 | 10/10 | 10/10 |
| 2^{nd} Pass | N/A | N/A | N/A | N/A |
| 3^{rd} Pass | N/A | N/A | N/A | N/A |
| Machine # 2 | | | | |
| 1^{st} Pass | 9/10 | 9/10 | 3/10 | 0/10 |
| 2^{nd} Pass | 1/1 | 1/1 | 4/7 | 0/10 |
| 3^{rd} Pass | N/A | N/A | 2/3 | 3/10 |
| Machine # 3 | | | | |
| 1^{st} Pass | 10/10 | 10/10 | 10/10 | 10/10 |
| 2^{nd} Pass | N/A | N/A | N/A | N/A |
| 3^{rd} Pass | N/A | N/A | N/A | N/A |
| Machine # 4 | | | | |
| 1^{st} Pass | 10/10 | 10/10 | 10/10 | 10/10 |
| 2^{nd} Pass | N/A | N/A | N/A | N/A |
| 3^{rd} Pass | N/A | N/A | N/A | N/A |
| Machine # 5 | | | | |
| 1^{st} Pass | 10/10 | 10/10 | 10/10 | 2/10 |
| 2^{nd} Pass | N/A | N/A | N/A | 1/8 |
| 3^{rd} Pass | N/A | N/A | N/A | 1/7 |
| Machine # 6 | | | | |
| 1^{st} Pass | 10/10 | 10/10 | 10/10 | 10/10 |
| 2^{nd} Pass | N/A | N/A | N/A | N/A |
| 3^{rd} Pass | N/A | N/A | N/A | N/A |
| # 1st Pass Failures | 1 | 1 | 7 | 18 |
| # 1st Passes | 60 | 60 | 60 | 60 |
| 1-Pass Acceptance Rate | 98.3% | 98.3% | 88.3% | 70.0% |
| # 2nd Pass Failures | 0 | 0 | 3 | 17 |
| 2-Pass Acceptance Rate | 100.0% | 100.0% | 95.0% | 71.7% |
| # 3rd Pass Failures | N/A | N/A | 1 | 13 |
| 3-Pass Acceptance Rate | N/A | N/A | 98.3% | 78.3% |
| # Machines with Issues | 1 | 1 | 1 | 2 |
| Affected Machines | # 2 | # 2 | # 2 | # 2 & |
| | | | | # 5 |

It seemed unusual that the samples with a 5.4 μm nickel thickness performed least well. FIG. 7 shows that these samples exhibited an excellent conductivity match to the U.S. five cent coins, especially at the highest measurement frequencies. This suggests that a nickel plating thickness greater than 4 to 5 μm may be difficult for some models of coinage acceptors to detect.

The final phase of investigation was to determine if the laboratory results could be reproduced on a larger scale, and to learn what the cost of manufacturing this alloy would be. Alloy strips suitable for the production of test blanks were produced. The composition was about 30±1% zinc, 0.4-0.5% nickel, manganese ranging from 5 to 7%, and the balance copper. The strip gauge was about 0.064 inch.

In all, 10 strips were produced, with compositions as shown in Table 5.

TABLE 5
Composition, Conductivity, and High-Speed Coin Sorter Results for Cu—Zn—Mn—Ni Blanks

| | Strip Number (By Increasing Manganese Content) | | | | | | | | | | U.S. Five |
|---|---|---|---|---|---|---|---|---|---|---|---|
| | 1 | 2 | 3 | 4 | 5 | 6 | 7 | 8 | 9 | 10 | Cent |
| Composition per ICP | | | | | | | | | | | |
| % Cu | 62.75 | 63.01 | 62.31 | 62.91 | 62.99 | 61.62 | 62.08 | 62.59 | 61.79 | 61.58 | 75 |
| % Zn | 31.90 | 30.89 | 31.27 | 30.27 | 30.19 | 31.46 | 30.96 | 30.21 | 30.83 | 30.99 | — |
| % Mn | 4.83 | 5.55 | 5.90 | 6.23 | 6.32 | 6.42 | 6.49 | 6.71 | 6.89 | 6.92 | — |
| % Ni | 0.52 | 0.55 | 0.52 | 0.59 | 0.50 | 0.50 | 0.47 | 0.49 | 0.49 | 0.51 | 25 |
| % Mn—AA Method | 4.57 | 5.10 | 5.52 | 5.65 | 6.00 | 5.97 | 6.13 | 6.12 | 6.49 | 6.40 | |
| Conductivity (% IACS)* | | | | | | | | | | | |
| As-Blanked | 6.38 | 5.89 | B5.60 | A5.52 | A5.31 | A5.26 | A5.26 | A5.17 | A5.03 | A4.99 | Test |
| Annealed Blanks | 6.83 | 6.24 | 5.87 | 5.82 | 5.59 | 5.52 | 5.52 | 5.42 | 5.26 | 5.19 | Circulation |
| 3 μm Nickel, 1X Anneal | 6.79 | 6.15 | 5.81 | 5.74 | B5.53 | A5.43 | B5.49 | A5.35 | A5.22 | A5.12 | Coin |
| 3 μm Nickel, 2X Anneal | 6.67 | 6.09 | 5.78 | 5.68 | 5.50 | C5.41 | C5.46 | B5.31 | A5.22 | A5.13 | Average |
| 5 μm Nickel, 1X Anneal | 6.55 | 6.01 | 5.62 | 5.56 | C5.33 | B5.28 | C5.28 | B5.19 | A5.00 | A4.98 | 5.46 |
| 5 μm Nickel, 2X Anneal | 6.49 | 6.00 | 5.62 | 5.58 | 5.36 | 5.33 | 5.29 | C5.25 | B5.05 | B5.06 | |
| 7 μm Nickel, 1X Anneal | 6.45 | 5.77 | 5.53 | 5.34 | 5.21 | C5.04 | C5.16 | C4.97 | B4.92 | 4.75 | |
| 7 μm Nickel, 2X Anneal | 6.31 | 5.84 | 5.47 | 5.41 | 5.18 | 5.15 | 5.14 | 5.06 | 4.89 | C4.87 | |

Scan Coin 4000 Results
A = All eight test parameters within 5% of average values for U.S. Five Cent Coins
B = Seven of eight test parameters within 5% of average values of U.S. Five Cent coins; one within 7.5%
C = Seven of eight test parameters within 5% of average values of U.S. Five Cent coins; one within 10%
*Notes: Conductivity values are the average of seven readings, taken at frequencies of 60, 68, 120, 240, 300, 480, and 960 kHz
“1X Anneal” refers to blanks subjected to a single 1250° F. annealing cycle after plating
“2X Anneal” refers to blanks subjected to a 1250° F. annealing cycle before plating and a 1000° F. stress-relief cycle after plating

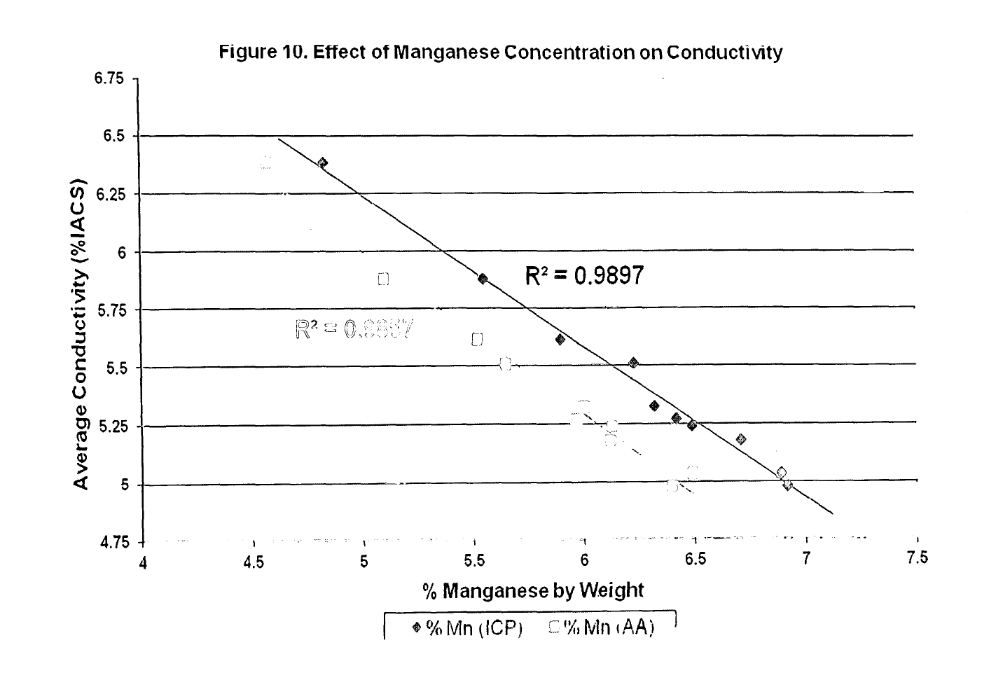

The compositions in Table 5 were determined by means of inductively coupled plasma spectroscopy (ICP). The samples were also analyzed using atomic absorption spectroscopy (AA), which had been used to analyze all of the samples produced to this point. As shown in FIG. 10, there were differences in conductivity noted between the two techniques for the manganese content. The AA readings averaged about 0.4% lower than the corresponding ICP numbers. The complete ICP composition readings are used in Table 5. The AA readings for manganese are also included.

Rimmed coin blanks, 0.827 inch in diameter, were produced from each of the 10 strips as in previous tests. Three different nickel plating thickness targets were selected: 3 μm, 5 μm, and 7 μm. Two different annealing approaches were also investigated: the first involved a 1250° F. cycle prior to plating, followed by a 1000° F. cycle after plating. The second used a single 1250° F. cycle after plating, to soften the base metal and relieve plating stresses simultaneously. The conductivity was measured at seven different frequencies at each step of the process. Table 5 shows the results for coin blanks from each of the ten strips in the as-blanked and pre-annealed conditions, as well as for all 60 combinations of plated coin blanks.

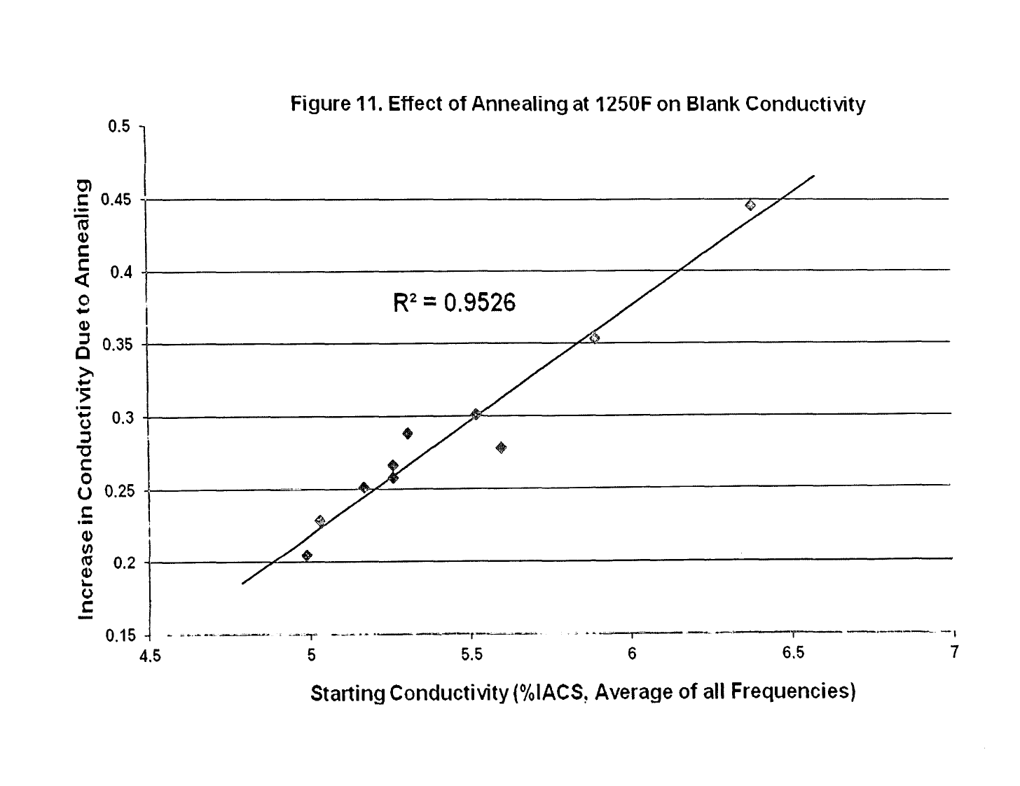

FIG. 11 shows the effect of annealing upon conductivity. It is interesting to note that, as the starting conductivity of the alloy is increased (i.e., the manganese content is decreased), the effect of annealing upon conductivity is increased.

The 60 sets of plated blanks, as well as 10 sets of unplated blanks (non-annealed), were then analyzed using a Scan Coin Active 4000 high-speed coin sorter (SC4000). In addition to measuring the coin diameter and thickness, it conducts four different measurements of conductivity and two of permeability. A set of currently circulated U.S. five cent coins was also analyzed, to establish baseline values for each of the eight parameters measured. The results for each of the sets tested with the SC4000 are shown in Table 5. Eight of the nickel-plated sets, as well as seven of the unplated blank sets, were determined to match the five cent coins to within ±5% of the baseline values for all eight parameters. Eight more nickel-plated sets and one of the unplated blank sets matched seven of the parameters, and were within ±7.5% of the remaining one. Nine additional nickel-plated sets matched seven of the parameters, and were within ±10% of the remaining one.

The SC4000 results provide several insights into EMS matching:
1. A simple conductivity match is no guarantee of success. For the nickel-plated blanks, the best matches show a noticeably lower conductivity than the original target conductivity of 5.4-5.5% IACS.
2. The permeability measurements are an important factor in coinage recognition. This aspect of EMS hadn't been addressed in previous tests.
3. Nickel plating thicknesses greater than 5 μm are generally unsatisfactory. This bears out the unexpected vending results observed with 5.4 μm nickel-plated blanks earlier.
4. As a general rule, a single annealing cycle after nickel plating appears to yield better EMS results.

As a final test of the findings of this phase of the investigation, the three tiers of candidates identified using the SC4000 machine were tested in a pair of vending machines, equipped with coinage acceptors from different manufacturers. Four additional sets were added to the test, two of which were expected to fail (Strip 1, 3 μm Ni, 1× anneal and Strip 4, 7 μm Ni, 2× anneal); one with marginal prospects (Strip 5, 5 μm Ni, 2× anneal); and one that had almost passed the highest criteria in the SC4000 tests, but was slightly above ±5% for two parameters (Strip 10, 7 μm Ni, 1× anneal). The results of these tests are shown in Table 6.

TABLE 6
High-Speed Coin Sorter and Vending Results for Cu—Zn—Mn—Ni Blanks

| | Strip Number (By Increasing Manganese Content) | | | | | | | | | | | | | | | | | |
|---|---|---|---|---|---|---|---|---|---|---|---|---|---|---|---|---|---|---|
| | 1 | 2 | 3 | | 4 | | 5 | | 6 | | 7 | | 8 | | 9 | | 10 | |
| % Mn - ICP Method | 4.83 | 5.55 | 5.90 | | 6.23 | | 6.32 | | 6.42 | | 6.49 | | 6.71 | | 6.89 | | 6.92 | |
| % Mn - AA Method | 4.57 | 5.10 | 5.52 | | 5.65 | | 6.00 | | 5.97 | | 6.13 | | 6.12 | | 6.49 | | 6.40 | |
| Vending - Machine # 1 | | | | | | | | | | | | | | | | | | |
| As-Blanked | — | — | B | 10 | A | 10 | A | 10 | A | 10 | A | 10 | A | 10 | A | 10 | A | 10 |

| | | | | | | | | | | | | | | | | |
|---|---|---|---|---|---|---|---|---|---|---|---|---|---|---|---|---|
| 3 μm Nickel, 1X Anneal | 0 | — | — | — | B | 10 | A | 10 | B | 10 | A | 10 | A | 10 | A | 10 |

| 3 μm Nickel, 2X Anneal | — | — | — | | — | | — | | C | 10 | C | 10 | B | 10 | A | 10 | A | 10 |
|---|---|---|---|---|---|---|---|---|---|---|---|---|---|---|---|---|---|---|
| 5 μm Nickel, 1X Anneal | — | — | — | | — | | C | 8 | B | 10 | C | 10 | B | 10 | A | 10 | A | 10 |
| 5 μm Nickel, 2X Anneal | — | — | — | | — | | | 4 | — | | — | | C | 10 | B | 10 | B | 10 |
| 7 μm Nickel, 1X Anneal | — | — | — | | — | | — | | C | 1 | C | 4 | C | 9 | B | 10 | | 10 |
| 7 μm Nickel, 2X Anneal | — | — | — | | | 0 | — | | — | | — | | — | — | | | C | 10 |
| Vending - Machine # 2 | | | | | | | | | | | | | | | | | | |
| As-Blanked | — | — | B | 9 | A | 10 | A | 10 | A | 10 | A | 10 | A | 10 | A | 10 | A | 8 |

| | | | | | | | | | | | | | | | | |
|---|---|---|---|---|---|---|---|---|---|---|---|---|---|---|---|---|
| 3 μm Nickel, 1X Anneal | 0 | — | — | — | B | 10 | A | 10 | B | 9 | A | 10 | A | 10 | A | 10 |

| 3 μm Nickel, 2X Anneal | — | — | — | — | — | | | 10 | C | 10 | B | 8 | A | 10 | A | 10 |
|---|---|---|---|---|---|---|---|---|---|---|---|---|---|---|---|---|
| 5 μm Nickel, 1X Anneal | — | — | — | — | C | 7 | B | 10 | C | 7 | B | 8 | A | 7 | A | 10 |

| | | | | | | | | | | | | | |
|---|---|---|---|---|---|---|---|---|---|---|---|---|---|
| 5 μm Nickel, 2X Anneal | — | — | — | — | 9 | — | — | C | 5 | B | 7 | B | 7 |

| | | | | | | | | | | | | | | |
|---|---|---|---|---|---|---|---|---|---|---|---|---|---|---|
| 7 μm Nickel, 1X Anneal | — | — | — | — | — | C | 0 | C | 3 | C | 0 | B | 2 | 0 |

| | | | | | | | | | | | |
|---|---|---|---|---|---|---|---|---|---|---|---|
| 7 μm Nickel, 2X Anneal | — | — | — | 1 | — | — | — | — | — | C | 0 |

Scan Coin 4000 Results
A = All eight test parameters within 5% of average values for U.S. Five Cent Coins
B = Seven of eight test parameters within 5% of average values of U.S. Five Cent coins; one within 7.5%
C = Seven of eight test parameters within 5% of average values of U.S. Five Cent coins; one within 10%
* Notes: Vending results are reported as the number of blanks out of 10 passing successfully on the first attempt
“1X Anneal” refers to blanks subjected to a single 1250° F. annealing cycle after plating
“2X Anneal” refers to blanks subjected to a 1250° F. annealing cycle before plating and a 1000° F. stress-relief cycle after plating

It is evident that the coinage acceptor in the second machine tested is more selective than that in the first. Still, the results are excellent in both machines for the eight nickel-plated sets and seven unplated blank sets that matched five cent coins to within ±5% of the baseline values for all eight parameters in the SC4000 (identified with the letter A).

For the second tier of samples (identified with the letter B), the results were just as good as the first-tier samples in the first machine, but less so in the second machine. Except for the one sample in this group with 7 μm plating thickness, the results were still reasonably good (7 out of 10 or better). Blanks rejected the first time were not sent through for a second and third pass, as had been done in previous tests. It is possible that a second or third pass would have resulted in acceptance of the remaining blanks from these sets.

For the third tier of samples (identified with the letter C), results were excellent in both machines for blanks with 3 μm of nickel plating, and also for samples with 5 μm of nickel plating in the first machine. In the second machine, the 5 μm samples show a drop-off in acceptance, and the 7 μm samples are poor across the board. In the first machine, the 7 μm samples show good results for strips 8-10, but are unsatisfactory when made from Strips 6 or 7.

For the remaining four sets of blanks tested, the blanks expected to fail did so in both machines. The set thought to be marginal was as expected, with 4 accepted in the first machine and 9 in the second. The set that was barely out of the ±5% range for two SC4000 parameters was excellent in the first machine, with 10 accepted, yet none were accepted in the second machine. This appears to be the result of the 7 μm plating layer.

The results of this testing suggest that the nickel plating thickness on Cu—Zn—Mn—Ni alloys should be limited to 5 μm maximum. This potential limitation shouldn't be a problem, as the Canadian five cent coin has a top plating layer of approximately 4 μm nickel, and it performs very well in circulation. The alloys of this disclosure are inherently corrosion-resistant, and the plating is primarily for appearance. If, however, a thicker finish is desired, white bronze plating can be applied, preferably over a Cu—Zn—Mn—Sn alloy as described earlier.

It is also possible that further investigation of alloying and plating interactions may allow for a greater nickel plating thickness. One issue that currently exists is the effect of coining upon electronic signature. Tests were run on uncoined blanks. Conductivity probes are designed to be pressed against a flat surface, whereas the conductivity sensors in coinage acceptors and sorting machines are designed to work without directly contacting the coin. The five cent coin conductivity measurements were likely affected to some degree by the lack of complete contact with the sensor probes. Conversely, the SC4000 and vending measurements on the tested blanks were likely affected by the fact that the surfaces were flat. This compromises the ability to make direct comparisons of blank and coin conductivity data.

Despite these limitations, these results verify the soundness of the approach. The sample strips and blanks tested in the initial phases of the investigation were produced relatively crudely. The materials used in the final phase were produced in a more sophisticated manner, but still on a laboratory scale. Clearly, with additional refinement and with the control advantages inherent with full-scale processes, even better results can be achieved.

While a close match to the signature of Alloy C71300 (75% copper/25% nickel) has been achieved, it is not the only cupronickel alloy in common use. Other cupronickel alloys include Alloy C70600 (90% copper/10% nickel, conductivity 9.1% IACS), Alloy C71000 (80% copper/20% nickel, conductivity 6.5% IACS), and Alloy C71500 (70% copper/30% nickel, conductivity 4.6% IACS). There is also a cupronickel alloy with 84% copper/16% nickel. Clearly, the greater the percentage of nickel within the alloy, the more economic incentive there is to use the alloys as produced above as a replacement in coinage and token applications. The test results have shown that Cu—Mn or Cu—Zn—Mn alloys can be produced that would match the conductivity of each of these cupronickel alloys, as well as any others within this range.

Other silvery-white coinage alloys besides cupronickel could also be matched by the approach disclosed above, primarily the family of alloys known as “nickel silver,” which contain varying amounts of copper, zinc, and nickel. Examples include Alloy C74500 (65% copper/25% zinc/10% nickel, conductivity 9% IACS), Alloy C75700 (65% copper/23% zinc/12% nickel, conductivity 8% IACS), Alloy C75400 (65% copper/20% zinc/15% nickel, conductivity 7% IACS), C75200 (65% copper/17% zinc/18% nickel, conductivity 6% IACS), and C77000 (55% copper/27% zinc/18% nickel, conductivity 5.5% IACS). A number of similar nickel silver alloys are used in international coinage, with conductivities in the same range as these alloys. Again, any of these could be matched for conductivity using Cu—Mn or Cu—Zn—Mn alloys, with the silvery-white color, if desired, being restored using nickel or white bronze plating.

Another concern that is addressed is the issue of nickel allergies and the potential classification of nickel as a carcinogen. The European Union recently passed legislation that restricts the use of various nickel compounds. When white bronze plating is applied over the Cu—Mn or Cu—Zn—Mn base alloy, the resulting coin or token is entirely nickel-free. White bronze plating for coinage and token applications is discussed in U.S. Pat. No. 7,296,370.

The present disclosure brings together metallurgical, electroplating, and electronic signature technology to create a unique “drop in” replacement for more expensive alloys in coinage applications. Its value is in large part determined by the relative costs of nickel, copper, and zinc, as well as the face value of the coin for which it is being considered. Nickel has ranged in price from about $4/lb to $24/lb over the past 5 years. Copper has ranged from about $1.20/lb to $4/lb over the same period. Zinc has ranged in price from $0.43 to $2.10/lb. At present, nickel is less than three times as expensive as copper, but in May 2007, it was over 6 times as expensive. Similarly, nickel is presently ten times as expensive as zinc, but in May 2007, it was nearly 14 times as expensive. During this same five year period, electrolytic manganese has ranged in price from about $0.80/lb to $3/lb.

In the case of the U.S. five cent coin, a conversion of the alloys identified above would enable the U.S. Mint to gradually withdraw the existing solid cupronickel version from circulation. This metal could then be recovered for use in the more cost-effective, higher-denomination, cupronickel-clad copper coins. All of this could be done without any impact to the vending industry or inconvenience to the public. With the U.S. Mint producing between 1 and 2 billion five cent coins in recent years, this represents a significant opportunity for savings. This opportunity could be much greater, in the tens of billions of blanks for several years, if the U.S. Mint withdrew the existing solid cupronickel coins from circulation at an accelerated rate.

Based on the foregoing, an alloy comprising by weight of about 30% zinc, about 6% to 7% manganese, less than 0.5% nickel and the balance copper will provide a suitable ally for modern day coinage. Manganese in the amount of about 6.5% by weight in this alloy composition works well.

Moreover, an alloy comprising by weight about 30% zinc, about 6% to 7% manganese, less than 0.5% tin and the balance copper will also provide a suitable alloy for modern coinage. Manganese in the amount of 6.5% by weight in this alloy composition works well.

Another desirable coinage alloy is an alloy comprising by weight about 30% zinc, about 6% to 7% manganese, less than 0.5% tin, less than 0.5% nickel and the balance copper will also provide a suitable alloy for modern coinage. Manganese in the amount of 6.5% by weight in this alloy composition works well.

It will be appreciated by those skilled in the art that the above alloys with silvery-white finish for coinage and token applications is merely representative of the many possible embodiments of the invention and that the scope of the invention should not be limited thereto, but instead should only be limited according to the following claims.

What is claimed is:

1. An alloy comprising copper, zinc and manganese, said alloy having an IACS conductivity between about 5.0 and 9.3.

2. The alloy of claim 1, further comprising a white bronze plating applied over said alloy.

3. The alloy of claim 1 further comprising a nickel plating applied over said alloy.

4. The alloy of claim 1, comprising by weight, about 30% zinc, about 3% to 7% manganese, less than 0.5% nickel and the balance copper.

5. (canceled)

6. (canceled)

7. The alloy of claim 1 wherein said IACS conductivity between about 5.0% and 9.3% extends over an electromagnetic sensor frequency range of about 240 kHz to 960 kHz.

8. The alloy of claim 1 comprising by weight, about 30% zinc, about 6% to 7% manganese, less than 0.5% tin and the balance copper.

9. (canceled)

10. (canceled)

11. The alloy of claim 1 comprising by weight, about 30% zinc, about 6% to 7% manganese, less than 0.5% tin, less than 0.5% nickel and the balance copper.

12. The alloy of claim 11 further comprising a white bronze plating applied over said alloy and wherein said manganese comprises about 6.5% by weight of said alloy.

13. The alloy of claim 11 further comprising a nickel plating applied over said alloy.

14. (canceled)

15. An alloy comprising by weight, about 30% zinc, about 3-7% manganese, less than 0.5% tin, less than 0.5% nickel, and the balance copper.

16. The alloy of claim 15 further comprising a white bronze plating applied over said alloy.

17. The alloy of claim 15 further comprising a nickel plating applied over said alloy.

18.-32. (canceled)

33. A method of reducing the amount of nickel in a cupronickel alloy while maintaining the cupronickel alloy's electromagnetic signature acceptance in a coin sensor, wherein said method comprises:
reducing the amount of nickel in the cupronickel alloy; and
adding zinc and manganese to the alloy in amounts that produce a new alloy with an electromagnetic signature about the same as said cupronickel alloy.

34. The method of claim 33, further comprising plating said alloy.

35. The method of claim 34, wherein said plating comprises at least one plating selected from the group consisting of white bronze plating and nickel plating.
